(19) United States
(12) Patent Application Publication
(10) Pub. No.: US 2022/0358852 A1
(43) Pub. Date: Nov. 10, 2022

(54) SYSTEMS AND METHODS FOR COMPENSATING CONTRIBUTORS OF ASSESSMENT ITEMS

(71) Applicant: Benjamin Chandler Williams, Somerville, MA (US)

(72) Inventor: Benjamin Chandler Williams, Somerville, MA (US)

(21) Appl. No.: 17/316,684

(22) Filed: May 10, 2021

(51) Int. Cl. G09B 7/02; G09B 7/07; G09B 7/10; G06F 40/284; G06K 9/62

(52) U.S. Cl. CPC G09B 7/02; G09B 7/07; G09B 7/10; G06F 40/284; G06K 9/6262

(57) ABSTRACT

Systems and methods are provided for compensating contributors, comprising writers, editors, and reviewers, of assessment items, comprising questions, answers, and answer explanations. The systems and methods presented comprise hardware architecture, computer-implemented processes, and instructions configured to carry out the processes for compensating contributors. A user may use the systems and methods to contribute assessment items, to take assessment items in an assessment, to select or have selected assessment items for an assessment, and/or to provide information related to assessment items. The present invention solves problems with the currently available systems and methods of compensating contributors of assessment items.

### CROSS-REFERENCE TO RELATED APPLICATIONS

This application claims priority to U.S. Application No. 62/987,728, filed Mar. 10, 2020, titled “Systems and Methods for Compensating Contributors of Assessment Items”. This application is being filed within fourteen months of the filing of U.S. Application No. 62/987,728, accompanied by a petition under 37 CFR § 1.78. Following 37 CFR § 1.78(b), and in particular § 1.78(b)(1)(iii), the delay in filing this subsequent nonprovisional application within the twelve-month period set forth in 37 CFR § 1.78(a)(1)(i) was unintentional.

### FIELD OF THE INVENTION

The presently disclosed subject matter relates to providing systems and methods for compensating contributors of assessment items, which may comprise assessment questions, answer choices, and/or explanations of answer choices.

### BACKGROUND OF THE INVENTION

Writing and editing assessment items, comprising assessment questions (also referred to herein as test questions), answer choices for assessment questions, and explanations of such answer choices, is well known. Prior art does exist for compensating the contributors of assessment items, where contributors comprise writers, editors, and/or reviewers of assessment items, but the available art does not compensate contributors based on statistical analysis of one or more factors which measure the quality of the assessment items; nor does the prior art compensate based on statistical analysis of feedback on the assessment items from people who have taken the questions in a testing situation, or based on feedback from other contributors.

### SUMMARY OF THE INVENTION

The present invention meets all these needs, by disclosing systems, and methods, and instructions stored in non-transitory computer-readable media for compensating the contributors of assessment items.

The present invention addresses the problems of the prior art, which do not present systems and methods for compensating contributors based on statistical analysis of one or more factors which measure the quality of the assessment items. The present invention also provides for compensating contributors based on statistical analysis of feedback on the assessment items from people who have used or reviewed the assessment items in a testing situation, or based on feedback from other contributors.

These aspects of the present invention, and others disclosed in the Detailed Description of the Drawings, represent improvements on the current art. This summary is provided to introduce a selection of concepts in a simplified form that are further described below in the Detailed Description of the Drawings. This Summary is not intended to identify key features or essential features of the claimed subject matter, nor is it intended to be used to limit the scope of the claimed subject matter. The terms “approximate” or “approximately” and similar conjugates mean, for purposes of this disclosure, values within 10% of each other or within 10% of a specified value or end-values of a range of values. The singular and plural are interchangeable and a term in the singular includes the plural, or vice-versa, unless such reading is contradicted by the context.

### BRIEF DESCRIPTION OF THE DRAWINGS

The foregoing summary, as well as the following detailed description of various aspects, is better understood when read in conjunction with the appended drawings. For the purposes of illustration, the drawings show exemplary aspects; but the presently disclosed subject matter is not limited to the specific methods and instrumentalities disclosed. In the drawings, like reference characters generally refer to the same components, or steps of the methods, throughout the different figures. In the following detailed description, various aspects of the present invention are described with reference to the following drawings, in which:

FIG. 1 is a dataflow diagram of a system for compensating contributors of assessment items according to an aspect of the present invention.

FIG. 2 is a flowchart of a method performed by the system of FIG. 1 according to an aspect of the present invention.

FIG. 3 is a flowchart of a method performed by the system of FIG. 1 according to an aspect of the present invention.

FIG. 4 depicts an exemplary system for carrying out the methods of the present invention according to an aspect of the present invention.

### DETAILED DESCRIPTION OF THE DRAWINGS

The presently disclosed invention is described with specificity to meet statutory requirements. But, the description itself is not intended to limit the scope of this patent. Rather, the claimed invention might also be configured in other ways, to include different steps or elements similar to the ones described in this document, in conjunction with other present or future technologies. Moreover, although the term “step” or similar terms may be used herein to connote different aspects of methods employed, the term should not be interpreted as implying any particular order among or between various steps herein disclosed unless and except when the order of individual steps is explicitly described.

In the following description, numerous specific details are set forth to provide a thorough understanding of the invention. But, the present invention may be practiced without these specific details. Structures and techniques that would be known to one of ordinary skill in the art have not been shown in detail, in order not to obscure the invention. Referring to the figures, it is possible to see the various major elements constituting the apparatus and methods of use of the present invention.

Assessment items may comprise assessment questions (also referred to herein as test questions), answer choices for assessment questions, and explanations of such answer choices. Each of a plurality of assessment questions may have any of a number of question characteristics, including but not limited to educational objectives comprising analogies, skills, and analysis, a degree of difficulty, a length, an expected-time-required, and more. Each of a plurality of answer choices may have any of a number of answer characteristics, including but not limited to a degree of difficulty, a range of difficulties, the prompt that introduces the assessment item, or others.

Prior art does exist for compensating the contributors of assessment items, where contributors comprise writers, editors, and/or reviewers of assessment items, but the available art does not compensate contributors based on statistical analysis of one or more factors which measure the quality of the assessment items including but not limited to changes or edits to any assessment items; nor does the prior art compensate based on statistical analysis of feedback on the assessment items from people who have taken the questions in a testing situation, or based on feedback from other contributors.

In addition to contributors, the present invention may be used by and is intended to be used by a plurality of test takers, where a test taker is a person or entity taking an assessment or other test, and a plurality of test administrators, where a test administrator is a person or entity administering or running a test, which may comprise selecting one or more assessment questions, that is to be created and may or may not be delivered to one or more test takers. Any particular test taker may be a student, a professional seeking continuing education credits, any person seeking certification in a subject area, or have another role or goal. Any particular test administrator may be a school official or teacher, or a school, a person or entity offering continuing education credits, or an entity offering certification in a subject area, or have another role or goal.

In one aspect, the present invention comprises a system for compensating contributors of assessment items, the system comprising: a plurality of user devices; a plurality of server devices, which comprises a plurality of input/output components, a plurality of processors, a plurality of memory components, a plurality of databases, and a plurality of computer-readable instructions stored in non-transitory computer-readable media; and wherein at least one of the plurality of server devices has stored on it information about compensating contributors of assessment items.

In one aspect, the present invention comprises a system wherein the at least one of the plurality of server devices employs at least one of an assessment module, a token compensation module, and an assessment provisioning module.

In one aspect, the present invention comprises a method for compensating contributors of assessment items by a system, the method comprising: the system selects a contributor of a plurality of assessment items, the system selects a first plurality of information related to the contributor, the system selects a second plurality of information related to the contributor, the system selects a first plurality of information about a plurality of assessment items, where the plurality of assessment items were contributed by the contributor, making a computation of a number of utility tokens using a plurality of token-computation factors, the plurality of token-computation factors comprising: the first plurality of information related to the contributor, the second plurality of information related to the contributor, and the first plurality of information about a plurality of assessment items, and storing an information about the number of utility tokens.

In one aspect, the present invention comprises a method wherein the plurality of token-computation factors further comprises a statistical method score of the plurality of assessment items.

In one aspect, the present invention comprises a method wherein the plurality of token-computation factors further comprises a plurality of feedback information about the plurality of assessment items.

In one aspect, the present invention comprises a method wherein the plurality of assessment items may be edited creating an edited plurality of assessment items, and wherein the plurality of token-computation factors further comprises a plurality of feedback information about the edited plurality of assessment items.

In one aspect, the present invention comprises a method wherein the plurality of token-computation factors further comprises a plurality of information on demand for the plurality of assessment items.

In one aspect, the present invention comprises a method wherein the plurality of token-computation factors further comprises a plurality of information on a degree of difficulty of contributing the plurality of assessment items.

In one aspect, the present invention comprises a method wherein the plurality of assessment items are reviewed for one or more instances of bias from a plurality of known biases, and wherein any instances of bias are stored in relation to the plurality of assessment items, and wherein the plurality of token-computation factors further comprises any instances of bias.

In one aspect, the present invention comprises a method wherein the plurality of token-computation factors further comprises at least a second plurality of information about the plurality of assessment items, where the second plurality of information about the plurality of assessment items is selected from a list of pluralities of information about the plurality of assessment items, the list of pluralities of information comprising: review of the plurality of assessment items by a third party; a measure of accuracy of facts underlying the plurality of assessment items; a statistical analysis of performance on the plurality of assessment items by a plurality of test takers; ratings of the plurality of assessment items by test takers; and a measure of the number of assessment items contributed by the contributor.

In one aspect, the present invention comprises a method wherein the plurality of token-computation factors further comprises a plurality of information on a performance, as a test-taker, of the contributor on at least a second plurality of assessment items, and where the second plurality of assessment items were not written by the contributor, and are related to the plurality of assessment items contributed by the contributor in a measure of a subject matter of the plurality of assessment items or in a measure of a format of the plurality of assessment items.

In one aspect, the present invention comprises a method wherein the contributor of the plurality of assessment items takes, as a test-taker, at least the second plurality of assessment items.

In one aspect, the present invention comprises a method wherein the plurality of assessment items comprise answer explanations, and wherein the plurality of token-computation factors further comprises at least a first plurality of information about the answer explanations.

In one aspect, the present invention comprises a method wherein the first plurality of information about the answer explanations comprises feedback about the answer explanations by at least one test-taker.

In one aspect, the present invention comprises a method wherein the plurality of token-computation factors further comprises information about the at least one test-taker.

In one aspect, the present invention comprises a method wherein the plurality of token-computation factors further comprises a plurality of information on a test format in which the plurality of assessment items are presented to a test-taker.

In one aspect, the present invention comprises a method wherein the plurality of token-computation factors further comprises a plurality of information on a level of security of a test taking environment in which the plurality of assessment items are presented to a test-taker.

In one aspect, the present invention comprises a method wherein the plurality of assessment items has been edited by a second contributor, creating a second edited plurality of assessment items, and wherein the plurality of token-computation factors further comprises a plurality of information about the second edited plurality of assessment items, wherein the second contributor who edited the plurality of assessment items has compensation computed using a second plurality of token-computation factors.

In one aspect, the present invention comprises a method for selecting assessment items for an instance of a test by a system, the method comprising: the system selects a test format from a plurality of test formats, and making an assessment of a level of security of the test format and making an assessment of a level of security of a test taking environment.

The present invention comprises a system 100 and methods for compensating contributors of assessment items.

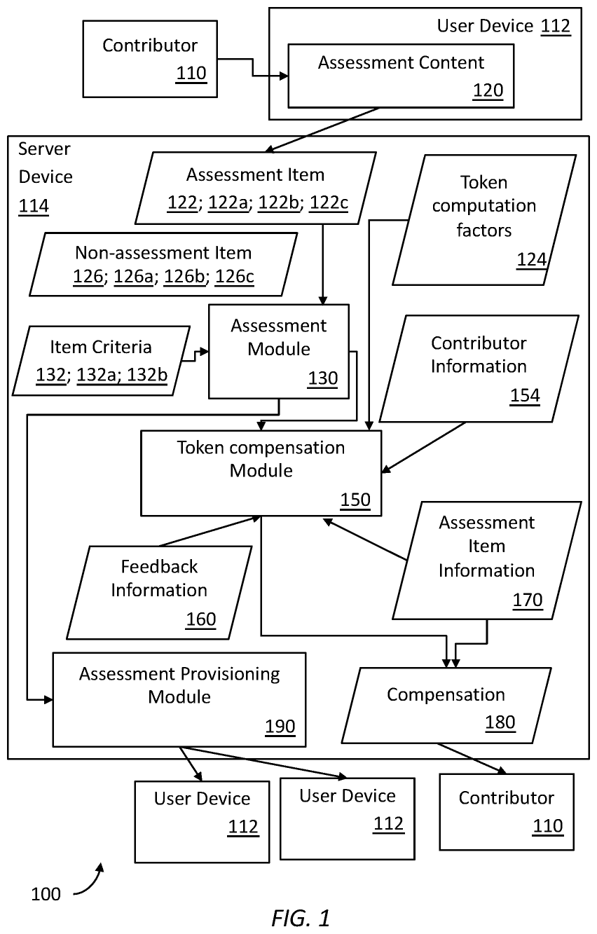

With reference to FIG. 1, a dataflow diagram is shown of a system 100 for compensating contributors of assessment items. The system 100 may be used by a contributor 110, where the contributor 110 uses, from a plurality of user devices 112, a user device 112 to enter assessment content 120. The assessment content 120 may be used to create a plurality of assessment items 122, which along with a plurality of assessment item criteria 132 may be used in an assessment module 130 to assess factors related to the plurality of assessment items 122. In some aspects of the present disclosure, the plurality of assessment items 122 and/or a second plurality of assessment items 122a, along with the plurality of assessment item criteria 132 and/or a second plurality of assessment item criteria 132a, may be used to evaluate any plurality of assessment items 122, second plurality of assessment items 122a, third plurality of assessment items 122b, fourth plurality of assessment items 122c, and so on for any number of assessment items 122. In some aspects of the present disclosure, the plurality of assessment items 122 and/or a second plurality of assessment items 122a, along with the plurality of assessment item criteria 132 and/or a second plurality of assessment item criteria 132a and/or a third plurality of assessment item criteria 132b, may be used to evaluate a plurality of non-assessment items 126, or any second plurality of non-assessment items 126a, third plurality of non-assessment items 126b, fourth plurality of non-assessment items 126c, and so on for any number of non-assessment items 126. As will be apparent to one of skill in the art, any number of pluralities of assessment items 122 or non-assessment items 126 are possible under the present disclosure. Assessment items 122 may comprise, but are not limited to, questions individually or as sets of questions, questions with one or more than one set of answers, tests, quizzes, software, interactive materials, written, audio, visual, audiovisual, tactile, haptic, coded, or other types of materials. Non-assessment items 126 may comprise, but are not limited to, worksheets, handouts, audiovisual information, audio or video recordings, readings in any written form, interactive materials that are not assessments, and other materials.

A plurality of token-computation factors 124 and a plurality of contributor information 154 may be used in a token compensation module 150 to compute a compensation result 180. A plurality of feedback information 160 and/or a plurality of assessment item information 170 may be used in a token compensation module 150 to compute the compensation result 180, and the compensation result 180 may be transferred or given to the contributor 110. Any of the plurality of contributor information 154, the plurality of feedback information 160, and/or the plurality of assessment item information 170 may comprise information on the edits, if any, that the contributor 110 has made to any plurality of assessment items 122, whether that plurality of assessment items 122 was contributed by that contributor 110, or was edited by that contributor 110, or was both contributed and edited by that contributor 110. A plurality of the plurality of assessment items 122 may be selected by an assessment provisioning module 190 and delivered by the assessment provisioning module 190 to the plurality of user devices 112.

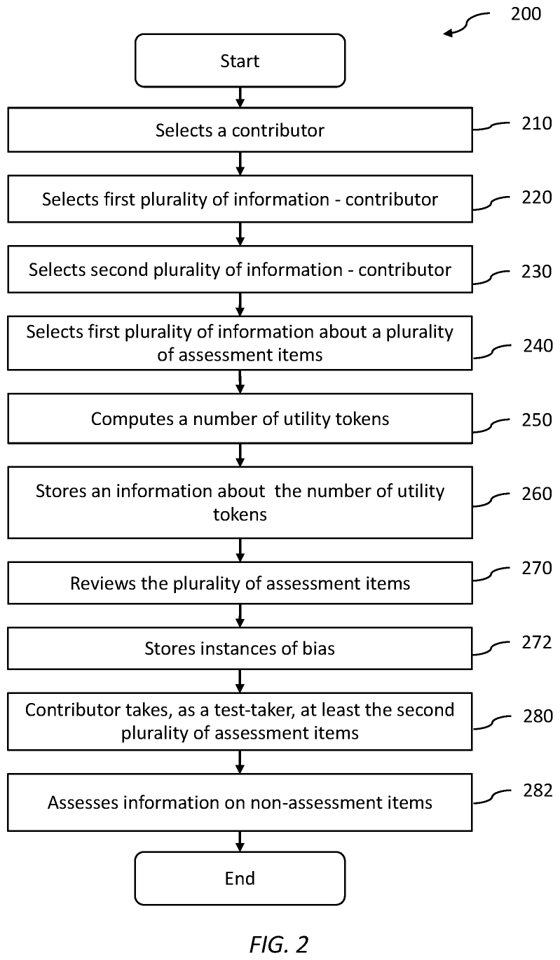

With reference to FIG. 2, a method 200 for compensating contributors of assessment items according to one aspect of the present invention is shown. The method comprises the following steps: the system 100 selects 210 a contributor of a plurality of assessment items; the system 100 selects 220 a first plurality of information related to the contributor; the system 100 selects 230 a second plurality of information related to the contributor; the system 100 selects 240 a first plurality of information about a plurality of assessment items, where the plurality of assessment items were contributed by the contributor; the system 100 computes 250 a number of utility tokens using a plurality of token-computation factors, the plurality of token-computation factors comprising: the first plurality of information related to the contributor, the second plurality of information related to the contributor, and the first plurality of information about a plurality of assessment items; and the system 100 stores 260 an information about the number of utility tokens. In some aspects of the method 200, the system 100 reviews 270 the plurality of assessment items for one or more instances of bias from a plurality of known biases, and the system 100 stores 272 any instances of bias in relation to the plurality of assessment items. In some aspects of the method 200, the system 100 assesses 280, as one of the plurality of token-computation factors 124, a plurality of information on a performance as a test-taker of the contributor 110 on at least a second plurality of assessment items 122, and where the second plurality of assessment items 122 were not written by the contributor 110, and are related to the plurality of assessment items 122 contributed by the contributor 110 in a measure of the subject matter of the plurality of assessment items 122 or in a measure of the format of the plurality of assessment items 122. In some aspects of the method 200, the system 100 assesses 282, as one of the plurality of token-computation factors 124, a plurality of information on a plurality of non-assessment items 126, and/or the second plurality of non-assessment items 126a, the third plurality of non-assessment items 126b, the fourth plurality of non-assessment items 126c, and so on.

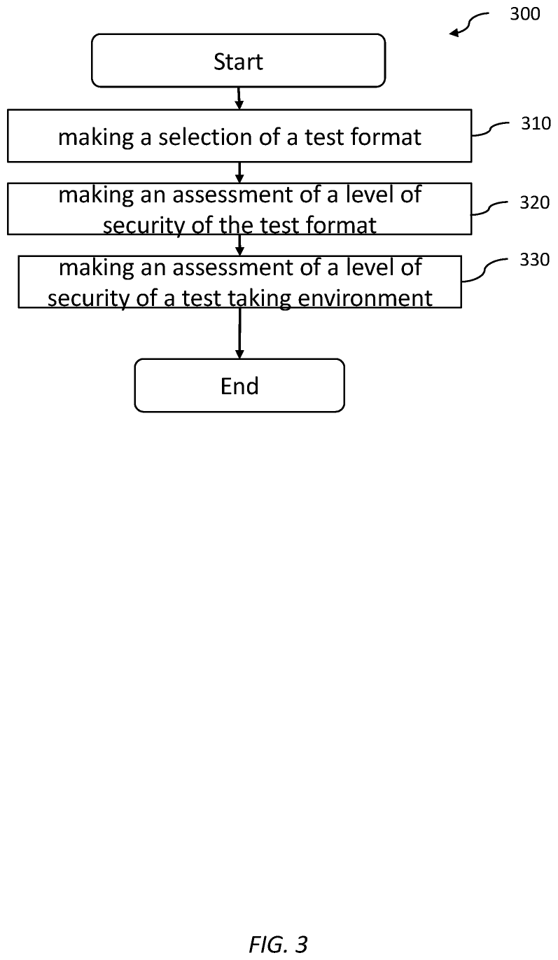

With reference to FIG. 3, a method 300 for selecting assessment items for an instance of a test, the method comprising: the system 100 selects 310 a test format from a plurality of test formats, and the system 100 assesses 320 a level of security of the test format and the system 100 assesses 330 a level of security of a test taking environment.

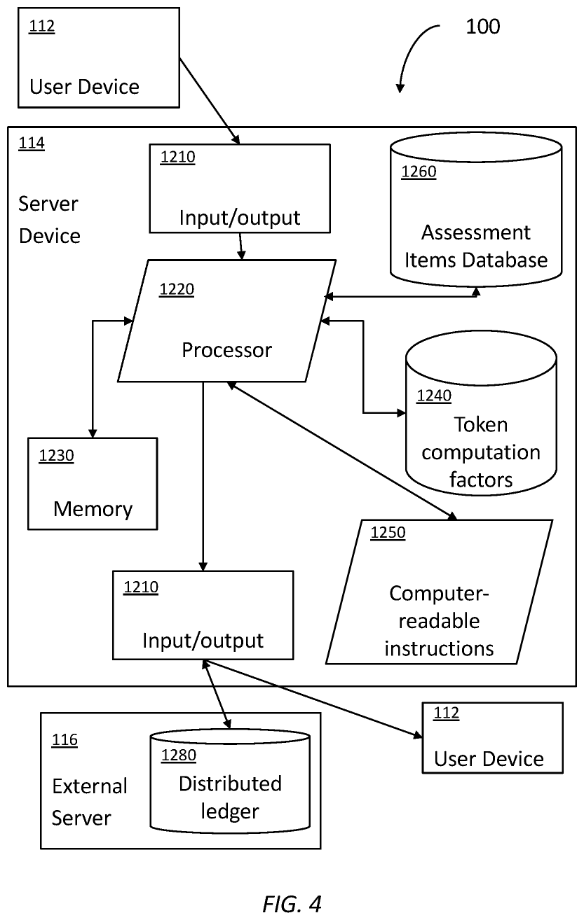

With reference to FIG. 4, an aspect of the system 100 and a plurality of server devices 114 are depicted in operation and communication for carrying out the methods of the present disclosure. The system 100 comprises a plurality of user devices 112 and a plurality of server devices 114. The plurality of server devices 114 may comprise a plurality of input/output components 1210, a plurality of processors 1220, a plurality of memory components 1230, a plurality of token computation factors databases 1240, a plurality of assessment items databases 1260, and a plurality of computer-readable instructions 1250 stored in non-transitory computer-readable media configured to carry out the various elements of the inventive methods. The non-transitory computer readable media may include the plurality of memory components 1230, the plurality of token computation factors databases 1240, the plurality of assessment items databases 1260, or other computer readable media. The plurality of computer-readable instructions 1250 may include instructions for carrying out any of the methods described in the present disclosure. In some aspects of the present invention, any of the foregoing databases, including but not limited to the plurality of token computation factors databases 1240 or the plurality of assessment items databases 1260, and/or the plurality of computer-readable instructions 1250, may exist outside of the plurality of server devices 114, on a plurality of external servers 116 and/or a plurality of user devices 112, and may be stored as a plurality of distributed ledgers 1280, and the plurality of distributed ledgers 1280 may be referred to as a blockchain or more than one blockchain.

The various modules and/or functions described above may be implemented by computer-executable instructions, such as program modules, executed by a conventional computer. Generally, program modules include routines, programs, objects, components, data structures, etc. that perform particular tasks or implement particular abstract data types. Those skilled in the art will appreciate that the invention may be practiced with various computer system configurations, including hand-held wireless devices such as mobile phones or PDAs, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer-storage media including memory storage devices.

The central computing device, also referred to as a processor, may comprise or consist of a general-purpose computing device in the form of a computer including a processing unit, a system memory, and a system bus that couples various system components including the system memory to the processing unit. Computers typically include a variety of computer-readable media that can form part of the system memory and be read by the processing unit. By way of example, and not limitation, computer readable media may comprise computer storage media and communication media. The system memory may include computer storage media in the form of volatile and/or nonvolatile memory such as read only memory (ROM) and random access memory (RAM). A basic input/output system (BIOS), containing the basic routines that help to transfer information between elements, such as during start-up, is typically stored in ROM. RAM typically contains data and/or program modules that are immediately accessible to and/or presently being operated on by the processing unit. The data or program modules may include an operating system, application programs, other program modules, and program data. The operating system may be or include a variety of operating systems such as Microsoft WINDOWS operating system, the Unix operating system, the Linux operating system, the Xenix operating system, the IBM AIX operating system, the Hewlett Packard UX operating system, the Novell NETWARE operating system, the Sun Microsystems SOLARIS operating system, the OS/2 operating system, the BeOS operating system, the MACINTOSH operating system, the APACHE operating system, the iOS operating system, the Android operating system, the Chrome operating system, an OPENSTEP operating system or another operating system or platform.

Any suitable programming language may be used to implement without undue experimentation the data-gathering and analytical functions described above. Illustratively, the programming language used may include assembly language, Ada, APL, Basic, C, C++, C*, COBOL, dBase, Forth, FORTRAN, Java, Modula-2, Pascal, Prolog, Python, Qt, REXX, and/or JavaScript for example. Further, it is not necessary that a single type of instruction or programming language be utilized in conjunction with the operation of the system and method of the invention. Rather, any number of different programming languages may be utilized as is necessary or desirable.

The computing environment may also include other removable/nonremovable, volatile/nonvolatile computer storage media. For example, a hard disk drive may read or write to nonremovable, nonvolatile magnetic media. A magnetic disk drive may read from or write to a removable, nonvolatile magnetic disk, and an optical disk drive may read from or write to a removable, nonvolatile optical disk such as a CD-ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The storage media are typically connected to the system bus through a removable or non-removable memory interface.

The processing unit that executes commands and instructions may be a general purpose computer, but may utilize any of a wide variety of other technologies including a special purpose computer, a microcomputer, mini-computer, mainframe computer, programmed micro-processor, micro-controller, peripheral integrated circuit element, a CSIC (Customer Specific Integrated Circuit), ASIC (Application Specific Integrated Circuit), a logic circuit, a digital signal processor, a programmable logic device such as an FPGA (Field Programmable Gate Array), PLD (Programmable Logic Device), PLA (Programmable Logic Array), RFID processor, smart chip, or any other device or arrangement of devices that is capable of implementing the steps of the processes of the invention.

The network over which communication takes place may include a wired or wireless local area network (LAN) and a wide area network (WAN), wireless personal area network (PAN) and/or other types of networks. When used in a LAN networking environment, computers may be connected to the LAN through a network interface or adapter. When used in a WAN networking environment, computers typically include a modem or other communication mechanism. Modems may be internal or external, and may be connected to the system bus via the user-input interface, or other appropriate mechanism. Computers may be connected over the Internet, an Intranet, Extranet, Ethernet, or any other system that provides communications. Some suitable communications protocols may include TCP/IP, UDP, or OSI for example. For wireless communications, communications protocols may include Bluetooth, Zigbee, IrDa or other suitable protocol. Furthermore, components of the system may communicate through a combination of wired or wireless paths.

Certain aspects of the present invention were described above. From the foregoing it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations. It is expressly noted that the present invention is not limited to those aspects described above, but rather the intention is that additions and modifications to what was expressly described herein are also included within the scope of the invention. Moreover, it is to be understood that the features of the various aspects described herein are not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description.

Accordingly, what is claimed is:

1. A system for compensating contributors of assessment items, the system comprising:
a plurality of user devices; and
a plurality of server devices, which comprises a plurality of input/output components, a plurality of processors, a plurality of memory components, a plurality of databases, and a plurality of computer-readable instructions stored in non-transitory computer-readable media;
wherein at least one of the plurality of server devices has stored on it information about compensating contributors of assessment items.

2. The system of claim 1, wherein the at least one of the plurality of server devices employs at least one of an assessment module, a token compensation module, and an assessment provisioning module.

3. A method for compensating contributors of assessment items by a system, the method comprising:
the system selects a contributor of a plurality of assessment items,
the system selects a first plurality of information related to the contributor, the system selects a second plurality of information related to the contributor, the system selects a first plurality of information about a plurality of assessment items, where the plurality of assessment items were contributed by the contributor,
making a computation of a number of utility tokens using a plurality of token-computation factors, the plurality of token-computation factors comprising:
the first plurality of information related to the contributor,
the second plurality of information related to the contributor, and
the first plurality of information about a plurality of assessment items; and
storing an information about the number of utility tokens.

4. The method of claim 3, wherein the plurality of token-computation factors further comprises a statistical method score of the plurality of assessment items.

5. The method of claim 3, wherein the plurality of token-computation factors further comprises a plurality of feedback information about the plurality of assessment items.

6. The method of claim 3, wherein the plurality of assessment items may be edited creating an edited plurality of assessment items, and wherein the plurality of token-computation factors further comprises a plurality of feedback information about the edited plurality of assessment items.

7. The method of claim 3, wherein the plurality of token-computation factors further comprises a plurality of information on demand for the plurality of assessment items.

8. The method of claim 3, wherein the plurality of token-computation factors further comprises a plurality of information on a degree of difficulty of contributing the plurality of assessment items.

9. The method of claim 3, wherein the plurality of assessment items are reviewed for one or more instances of bias from a plurality of known biases, and wherein any instances of bias are stored in relation to the plurality of assessment items, and wherein the plurality of token-computation factors further comprises any instances of bias.

10. The method of claim 3, wherein the plurality of token-computation factors further comprises at least a second plurality of information about the plurality of assessment items, where the second plurality of information about the plurality of assessment items is selected from a list of pluralities of information about the plurality of assessment items, the list of pluralities of information comprising:
review of the plurality of assessment items by a third party;
a measure of accuracy of facts underlying the plurality of assessment items;
a statistical analysis of performance on the plurality of assessment items by a plurality of test takers;
ratings of the plurality of assessment items by test takers; and
a measure of the number of assessment items contributed by the contributor.

11. The method of claim 3, wherein the plurality of token-computation factors further comprises a plurality of information on a performance, as a test-taker, of the contributor on at least a second plurality of assessment items, and where the second plurality of assessment items were not written by the contributor, and are related to the plurality of assessment items contributed by the contributor in a measure of a subject matter of the plurality of assessment items or in a measure of a format of the plurality of assessment items.

12. The method of claim 11, wherein the contributor of the plurality of assessment items takes, as a test-taker, at least the second plurality of assessment items.

13. The method of claim 3, wherein the plurality of assessment items comprise answer explanations, and wherein the plurality of token-computation factors further comprises at least a first plurality of information about the answer explanations.

14. The method of claim 13, wherein the first plurality of information about the answer explanations comprises feedback about the answer explanations by at least one test-taker.

15. The method of claim 14, wherein the plurality of token-computation factors further comprises information about the at least one test-taker.

16. The method of claim 3, wherein the plurality of token-computation factors further comprises a plurality of information on a test format in which the plurality of assessment items are presented to a test-taker.

17. The method of claim 3, wherein the plurality of token-computation factors further comprises a plurality of information on a level of security of a test taking environment in which the plurality of assessment items are presented to a test-taker.

18. The method of claim 3, wherein the plurality of assessment items has been edited by a second contributor, creating a second edited plurality of assessment items, and wherein the plurality of token-computation factors further comprises a plurality of information about the second edited plurality of assessment items, wherein the second contributor who edited the plurality of assessment items has compensation computed using a second plurality of token-computation factors.

19. A method for selecting assessment items for an instance of a test by a system, the method comprising:
the system selects a test format from a plurality of test formats,
making an assessment of a level of security of the test format, and
making an assessment of a level of security of a test taking environment.
